(19) United States
(12) Patent Application Publication
(10) Pub. No.: US 2024/0423256 A1
(43) Pub. Date: Dec. 26, 2024

(54) Nanoemulsion For A Beverage

(71) Applicant: DIAGEO GREAT BRITAIN LIMITED, London (GB)

(72) Inventors: Antonio Sullo, London (GB); Sonia Florence Holland, London (GB)

(21) Appl. No.: 18/693,368

(22) PCT Filed: Oct. 6, 2022
(86) PCT No.: PCT/GB2022/052530

§ 371 Date: Mar. 19, 2024

(30) Foreign Application Priority Data
Oct. 14, 2021 (GB) 2114698.0

(51) Int. Cl. A23L 27/00; A23J 7/00; A23L 2/385; A23L 2/52; A23L 29/10; C12G 3/06

(52) U.S. Cl. CPC A23L 27/80; A23J 7/00; A23L 2/385; A23L 2/52; A23L 29/10; C12G 3/06

(57) ABSTRACT

A nanoemulsion for a non-alcoholic beverage. The nanoemulsion comprises: a plurality of oil droplets with a z-average droplet size of less than 100 nm; an aqueous phase and a surfactant system. The oil droplets contain a hydrophobic compound and disperses in the aqueous phase which contains water and a co-solvent, e.g. glycerol. The surfactant system includes a sucrose ester and a lecithin, e.g. sucrose monopalmitate and a highly hydrolyzed sunflower lecithin. The dilutable nanoemulsion is useful for flavouring a non-alcoholic version of a spirit beverage, such as gin, where the component flavours thereof comprise of hydrophobic compounds and are typically non-soluble in water.

The present invention relates to a nanoemulsion for a beverage, particularly a nanoemulsion with stability at low pH for the purposes of carrying a hydrophobic compound, such as a flavouring in a non-or low-alcoholic beverage product.

### BACKGROUND TO THE INVENTION

The characteristic botanical aroma of a drinking spirit such as gin, made by traditional distillery methods, is provided by a class of compounds (e.g. terpenes in the case of gin) which are sparingly soluble in water. Solubility is not an issue in a full-strength gin because the concentration of ethanol (e.g. 40% by volume) is sufficient to solubilize those compounds.

However, in the case where it is desirable to mimic spirit taste and smell in a non-alcoholic version of the product, such aroma compounds, which are hydrophobic, cannot simply be added as a direct ingredient because of the insolubility mentioned above. The phases will simply separate out.

One solution for overcoming the solubility limit of such aroma compounds in water is to disperse them in the form of droplets (emulsion) stabilised by surfactants. However, known formulation techniques for an emulsion do not produce satisfactory results because the resultant liquid is cloudy. Consumers of spirits expect the product to be clear, so a high level of turbidity is unacceptable.

It is noteworthy that a microemulsion, as understood by a skilled person, is distinctly different from a nanoemulsion. Typically, a nanoemulsion is kinetic/metastable but thermodynamically unstable, whereas a microemulsion is thermodynamically stable and forms without energy input.

WO2016/064828 describes a translucent flavour nanoemulsion containing a flavour oil phase, an aqueous phase and a surfactant system having a first and second lecithin. The resultant formulation has about 30% more lecithin than the invention described hereinbelow, which is responsible for a slightly yellow tinge to the final beverage.

The majority of non-alcoholic products are made at pH between 2.5 and 7. In the art it is generally understood that anything below 4 is “low pH”. Indeed, in the particular field of beverages, anything below 4 is considered “low pH”.

### SUMMARY OF THE INVENTION

The present invention seeks to provide a system for a beverage containing a hydrophobic compound, which could comprise of a flavour system, that has a low level of turbidity, in other words it is a low pH, clear nanoemulsion or at least provides a useful choice for formulating non-or low-alcoholic beverage products. A nanoemulsion in the present context requires optical clarity, stability and is dilutable from a concentrate for use in a consumable beverage.

In a first aspect the invention provides a pH stable, clear nanoemulsion for a beverage according to claim 1. The invention effectively relates to a low pH stable nanoemulsion comprising: a plurality of oil droplets; an aqueous phase; and a surfactant system; wherein each of the oil droplets, having a z-average droplet size of less than 100 nm (i.e. z-average is a value derived from the intensity size distribution as measured by dynamic light scattering and where “size” refers to the greatest cross-width), contains a hydrophobic compound (e.g. a flavour) and disperses in the aqueous phase; the aqueous phase contains water and, preferably, a co-solvent; the surfactant system includes a sucrose ester and a lecithin. The invention can be alternatively described as a low pH stable, nanoemulsion for a clear beverage comprised of: at least one hydrophobic compound; a mixture of surfactants comprised of a first surfactant with a Hydrophilic-Lipophilic Balance, HLB, value higher than 15 (e.g. sucrose ester preferably), and a second surfactant with an HLB value between 4 and 8 (e.g. lecithin); and an aqueous phase containing a co-solvent. The HLB (hydrophilic/lipophilic/balance) number of a surfactant is an empirical measure of its relative hydrophobicity.

In a preferred form, the nanoemulsion is kinetically stabilised and can be diluted without affecting stability by means of changing in droplet size or flocculation during storage. The ability to dilute is useful because a concentrate will be prepared for later dilution into a consumable beverage with desirable taste characteristics.

In the context of the invention the stability of “low pH stable” refers to the ingredients not coming out of solution or changing in droplet size, clarity, etc. If a nanoemulsion were not low pH stable then these negative properties would be observed in the low pH environment relatively quickly, e.g. from within a day to several weeks. Stability at low pH should not be confused with overall shell life which, for a product of this nature, may be one or more years.

The nanoemulsion as claimed refers to both a concentrated preparation and its diluted drinkable form (i.e. either can be considered nanoemulsions). A nanoemulsion according to the invention maintains stability upon dilution, i.e. no change in droplet size, and such droplet size can be measured to confirm stability. The range of oil concentrations in the final ready-to-consume liquid will be approximately 0.01 to 0.5 g/L, preferably less than 0.25 g/L. Droplet size in both the concentrated liquid and diluted/drinkable form at such ranges are measurable. For the avoidance of doubt the liquid beverage is claimed herein.

In one form, the flavour (i.e. hydrophobic compound) may include terpene or a mixture of terpenes (e.g. pinene, myrcene and limonene) or any other hydrophobic substance.

The class of hydrophobic compounds may be defined by its log P value. Specifically, there are numerous examples of hydrophobic flavour compounds with limited solubility and, in general, hydrophobicity is commonly measures as Log Kow, also known as Log P, which is the partition coefficient of a molecule between aqueous and lipophilic phases, usually octanol and water.

Log P is inversely related to solubility and therefore often used to indicate the solubility properties of hydrophobic compounds. In general, compounds considered to be hydrophobic in nature, with relatively low solubility in water, possess a Log P value higher than 2. Accordingly, in the present invention the hydrophobic compound would have a log P value 2 or higher.

In particular forms and combinations of the invention:
The weight ratio between the surfactant system and hydrophobic compounds, may be 0.3:1 to 1:1.
The concentration of the hydrophobic compound is in the range of 10 to 40 g/L.
The first surfactant (e.g. sucrose ester) may be sucrose monolaurate, sucrose monopalmitate or a combination thereof.
The second surfactant (e.g. lecithin) may be a (e.g. highly hydrolyzed) sunflower lecithin.
The weight ratio between the first and second surfactant (sucrose ester and lecithin) in the surfactant system may be 70:30 to 20:80,
The co-solvent may be a polyol (e.g. glycerol, propylene glycol or a mixture of both or other equivalents). The concentration of the polyol may be 1 to 500 g/L e.g. 100 to 400 g/L propylene glycol.
The pH of the nanoemulsion should be in the range of 3.0 to 8.0, preferably 3.4 to 7.
The nanoemulsion average (or more particularly, z-average) droplet size should be 100 nm or less, preferably 70 nm or under.
The liquid beverage should preferably have a turbidity of 5 NTU or less in order to be considered clear. However, some variation (including higher NTU) may be possible, particularly where the liquid has some colour. “Clear” as disclosed herein encompasses substantially transparent beverages with no colour, like gin, and those with some colour/tint, like whisky.
The beverage in which the nanoemulsion is found may contain alcohol. Preferably the beverage product has relatively low alcohol content compared to a full-strength distilled spirit, e.g. up to 20%, but probably 15% ABV or less in practice.

In a further aspect of the invention there is provided a method of preparing a nanoemulsion, e.g. of claim 1, the method comprising the steps of:
a) providing an aqueous phase containing a sucrose ester and a cosolvent;
b) providing an oil phase containing a hydrophobic compound (e.g. a flavour) and a lecithin;
c) emulsifying the oil phase into aqueous phase, thereby obtaining the nanoemulsion.

This aspect of the invention may generally be considered a method of preparing a nanoemulsion for carrying a hydrophobic compound to be used in a beverage, comprising:
providing at least one hydrophobic compound, which can be aromatic;
providing a first surfactant, being hydrophilic, and a second surfactant, being lipophilic to serve as a stabilizer for the at least one hydrophobic compound;
mixing the at least one hydrophobic compound, first surfactant and second surfactant to form the nanoemulsion.

The first surfactant has an HLB value higher than 15, and second surfactant has an HLB value of 5 to 8. The surfactants may be combined in a ratio of between 20:80 to 70:30, more specifically 60:40 to 40:60.

As mentioned, the hydrophobic compound may include an aroma such as a terpene or a mixture of terpenes, e.g. pinene, myrcene and limonene. The first surfactant may be a sucrose ester, e.g. sucrose monopalmitate (SPM), and the second surfactant may be lecithin, e.g. sunflower lecithin (SL).

An advantageous surfactant to oil ratio should be kept low, e.g. 1:3. However, such ratio May 25 be up to 1:1, e.g. 1:2.

In a concentrated form the product may comprise, per liter of total volume:
water in the amount of 200 g to 980 g;
the hydrophobic compound(s) in the amount of up to 30 g/L; and
the surfactant combination in the amount of up to 10 g/L.
propylene glycol in the amount of 100 to 400 g/L
glycerol in the amount of 0 to 600 g/L.

In one form of the method, mixing is performed in a high shear mixer. Propylene glycol may be added as a cosolvent in the aqueous solution, e.g. in the amount of 100-500 g/L prior to mixing. The mixture may be homogenized up to 400 bar.

In a yet further aspect the invention encompasses a beverage containing the hydrophobic compound carrier, i.e. a nanoemulsion.

The hydrophobic compound carrier may be diluted from a concentrate, ready for use; i.e. obtaining the concentrate for further effective dilution of the at least one hydrophobic compound to 0.05 to 0.15 g/L

So that the clarity of the final liquid is maintained, droplets will need to be small enough so as not to significantly increase the scattering of light. As a generalised rule, droplets with a z-average size less than 100 nm do not increase the turbidity of the final liquid. A turbidity of less than 5 NTU is considered a practical threshold to ensure clarity.

### BRIEF DESCRIPTION OF THE ACCOMPANYING FIGURES

FIG. 1A shows the changes in droplet size as a function of propylene glycol concentration and surfactant ratio for hydrophobic compounds mixture of Log P 3.16;

FIG. 1B shows the changes in droplet size as a function of propylene glycol concentration and surfactant ratio for hydrophobic compounds mixture of Log P 4.5; and

FIG. 2 shows an example process for producing a nanoemulsion according to the invention.

### DETAILED DESCRIPTION OF AN EMBODIMENT

The following description presents exemplary embodiments and, together with the figures, serves to explain principles of the invention. However, the scope of the invention is not intended to be limited to the precise details of the embodiments, since variations will be apparent to a skilled person and are deemed also to be covered by the description. Terms for formulation components used herein should be given a broad interpretation that also encompasses compounds/ingredients with equivalent functions and features. In some cases alternatives may be suggested but such are not intended to be exhaustive.

Descriptive terms should also be given the broadest possible interpretation; e.g. the term “comprising” as used in this specification means “consisting at least in part of” such that interpreting each statement in this specification that includes the term “comprising”, features other than that or those prefaced by the term may also be present. Related terms such as “comprise” and “comprises” are to be interpreted in the same manner.

By way of overview of the invention, a concentrate nanoemulsion (e.g. 10 g/L of hydrophobic compounds, but may be higher, such as 30-50 g/L) was produced using a high pressure homogenizer at 400 bar. Two different types of surfactant were selected, firstly a hydrophilic (e.g. sucrose monopalmitate, SMP) and secondly a lipophilic (e.g. highly hydrolyzed lecithin), at a specific ratio which provides stability as well as small droplet size.

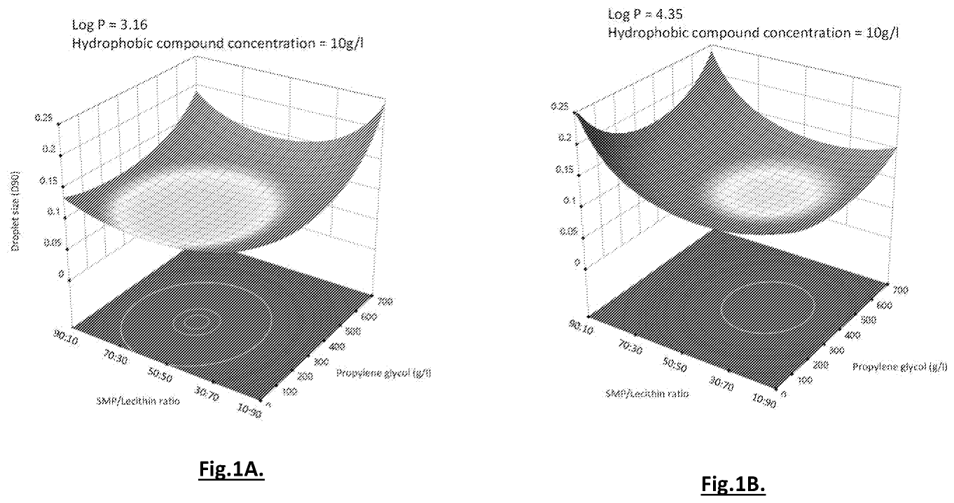

FIG. 1A shows the changes in droplet size D90 (i.e. derived from the volume size distribution, and it represents the maximum particle diameter below which 90% of the sample volume exists). D90 was chosen (instead of z average) to conduct the study and to find out the optimum ranges. However, within the optimum ranges, all the emulsions will have a Z-average of less than 100. Also, to measure the droplet size in the final product, Z-average is most convenient.

Particularly, FIGS. 1A and 1B illustrate 3D surface plots of droplet size achieved dependent on the ratio of the surfactants and propylene glycol concentration, e.g. change in droplet size as a function of the SMP/Lecithin ratio and propylene glycol. FIG. 1A shows results for emulsion concentrate of a mixture of hydrophobic aroma compounds having a weighted average log P of 3.16 at pH 7, whereas FIG. 1B shows results for emulsion concentrate of a mixture of flavour compounds having a log P of 4.35 at pH 7.

It can be observed that emulsions containing flavour with a log P of 3.16 show a minimum in droplet size for SMP/lecithin ratio between about 30:70 and 60:40 and a propylene glycol concentration between 0 and 400 g/L. The minimum droplet size is obtained at surfactant ratio of 55:45 and a propylene glycol concentration of 250 g/L.

Emulsions concentrate containing flavour with a log P of 4.35 according to FIG. 1B show a minimum in droplet size for SMP/lecithin ratio between 50:50 and 30:70 and a propylene glycol concentration between 250 and 450 g/L. The minimum droplet size is obtained at a surfactant ratio of 35:65 and a propylene glycol concentration of 400 g/L.

By way of further background to understand the nature of the invention, laboratory results are outlined below, utilizing three different flavour systems. Sucrose monopalmitate (SPM) and sunflower lecithin (SL) were selected as surfactants.

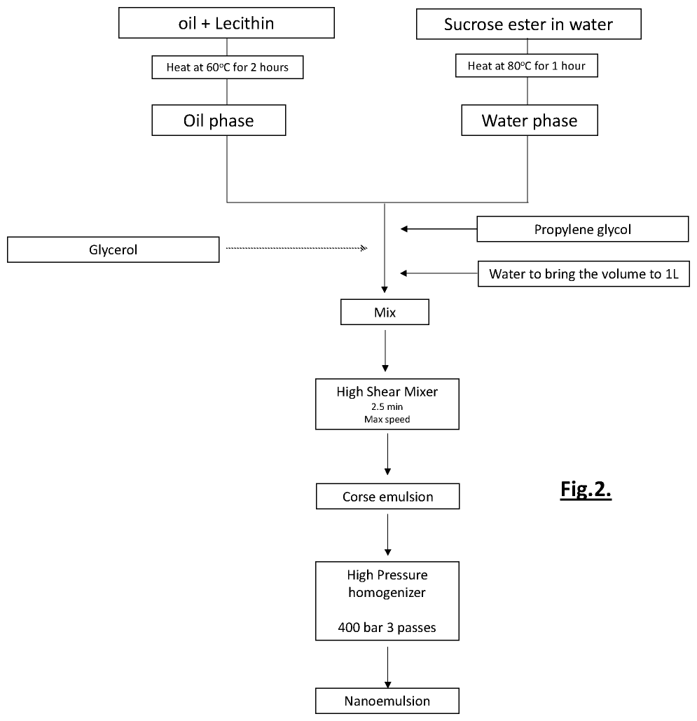

Samples were prepared, e.g. according to the process of FIG. 2, by dispersing the SL in the oil phase at 60° C. while SMP was hydrated in the water phase at 85° C. for 2 hours under constant shear. The two phases, together with propylene glycol, were then mixed for 2 minutes using a high shear mixer and then homogenized at 400 bar (3 passes).

### EXAMPLE 1

Formulation 1 - LogP 4.4

| Ingredient | Concentration (g/L) |
|---|---|
| Limonene | 9 |
| Linalool | 1 |
| Propylene glycol | 400 |
| Highly hydrolyzed sunflower lecithin | 7 |
| Sucrose monopalmitate | 3 |
| Water | To 1 L |

Particle size Z-average: 63

### EXAMPLE 2

Formulation 2 - LogP 4.1

| Ingredient | Concentration (g/L) |
|---|---|
| Pinene | 19.5 |
| Linalool | 10.5 |
| Propylene glycol | 300 |
| Highly hydrolyzed sunflower lecithin | 5 |
| Sucrose monopalmitate | 5 |
| Water | To 1 L |

Particle size Z-average: 64

### EXAMPLE 3

Formulation 3 - Log P 3.6

| Ingredient | Concentration (g/L) |
|---|---|
| Juniper oil | 30 |
| Propylene glycol | 300 |
| Highly hydrolyzed sunflower lecithin | 5 |
| Sucrose monopalmitate | 5 |
| Water | To 1 L |

Particle size Z-average: 61

### EXAMPLE 4

formulation 4 - LogP 4.6

| Ingredient | Concentration (g/L) |
|---|---|
| Pinene | 9 |
| Linalool | 1 |
| Propylene glycol | 400 |
| Highly hydrolyzed sunflower lecithin | 6 |
| Sucrose monopalmitate | 4 |
| Water | To 1 L |

Particle size Z-average: 61

Such concentrates did not show any sign of instability after been stored at 20° C. for three months. In practice, the concentrate is then diluted one hundred-fold to obtain a concentration of approximately 0.1 g/L needed in the final product. Turbidity of the final liquid is less than 5 NTU.

Table 1 below shows the turbidity of pH 3.4 solution containing 0.1 g/L of oil of each nanoemulsion formulation.

TABLE 1

| | Concentration of | | | |
|---|---|---|---|---|
| | nanoemulsion in | | Turbidity | Droplet Size - |
| | the final liquid | | NTU | Z average |
| Formulation 1 | 10 | mL/L | 3.94 | 47 |
| Formulation 2 | 3.3 | mL/L | 3.64 | 53 |
| Formulation 3 | 3.3 | mL/L | 2.40 | 70 |
| Formulation 4 | 10 | mL/L | 4.66 | 60 |

Table 2 below shows stability over time after dilution. The sample was prepared by diluting the nanoemulsion (10 g/L of oil; 30/70 sucrose monoester/lecithin ratio;) into water containing 0.33 g/L of trisodium citrate and a requisite amount of citric acid to lower the pH to 3.5.

Stability at low pH is particularly important because the majority of the liquids in this category of beverages (e.g. a non-alcoholic gin) have a pH around that tested, i.e. 3.5.

TABLE 2

| | Droplet | Droplet | | |
|---|---|---|---|---|
| Formulation | size day 0 | size day 14 | Turbidity NTU | Turbidity NTU |
| 1 | 47 | 43 | 3.94 | 1.53 |
| 2 | 53 | 40 | 3.64 | 0.98 |
| 3 | 70 | 47 | 3.72 | 1.01 |
| 4 | 60 | 49 | 5.38 | 1.88 |

It can be observed that both droplet size and turbidity decrease over time. Therefore, the present invention is particularly suited to use as a dilutable formulation which does not lose its useful properties over time.

By way of conclusion, a pH stable nanoemulsion concentrate (approximately 1% of oil) was successfully developed using a mixture of sucrose monopalmitate and sunflower lecithin. As outlined, the nanoemulsion comprises a plurality of oil droplets, e.g. less than 70 nm across, an aqueous phase and a surfactant system. The oil droplets contain a hydrophobic compound (flavour) and disperses in the aqueous phase which contains water and a co-solvent, e.g. glycerol. The surfactant system includes a sucrose ester and a lecithin, e.g. sucrose monopalmitate and a highly hydrolyzed sunflower lecithin. The nanoemulsion is useful for flavouring a non-alcoholic version of a spirit beverage, such as gin, where the component flavours thereof are typically non-soluble in water.

1.-22. (canceled)

23. A liquid beverage comprising:
no alcohol, or wherein a concentration of alcohol in the liquid beverage is 15% ABV or less; and
a low pH stable nanoemulsion consisting of:
a plurality of oil droplets, having a z-average droplet size of less than 100 nm;
an aqueous phase consisting of water and a co-solvent consisting of propylene glycol and/or glycerol; and
a two surfactant system including a first surfactant having an HLB value above 15 and a second surfactant with an HLB value between 4 and 8;
wherein each of the oil droplets contains a hydrophobic flavour compound or compounds having a Log P value of 2 or greater dispersed in the aqueous phase;
the weight ratio between the surfactant system and the hydrophobic flavour compound or compounds is between 0.3:1 and 1:1;
the first surfactant is selected from the group consisting of sucrose monolaurate or sucrose monopalmitate; and
the second surfactant is a highly hydrolyzed sunflower lecithin.

24. The beverage of claim 23, wherein the nanoemulsion is diluted with water in a ratio up to 3:100.

25. The beverage of claim 23, wherein, in the nanoemulsion, the hydrophobic flavour compound or compounds is a terpene or a mixture of terpenes selected from pinene, myrcene and limonene.

26. The beverage of claim 23, wherein, in the nanoemulsion, the weight ratio between the first surfactant and second surfactant is 30:70 to 80:20.

27. The beverage of claim 23, wherein, in the nanoemulsion, the co-solvent is at a concentration of 1 to 800 g/L.

28. The beverage of claim 23, wherein the z-average droplet size in the nanoemulsion is less than 70 nm.

29. The beverage of claim 23, wherein the liquid beverage has a turbidity of 5 NTU or less.

30. The beverage of claim 29, wherein the concentration of oil droplets in the beverage is 0.01 to 0.5 g/L.

31. A method of preparing a nanoemulsion for the liquid beverage, the method comprising the steps of:
providing an aqueous phase containing water, sucrose monolaurate or sucrose monopalmitate and a co-solvent consisting of propylene glycol and/or glycerol;
providing an oil phase containing a hydrophobic flavour compound or compounds having a Log P value of 2 or greater, and highly hydrolyzed sunflower lecithin;
emulsifying the oil phase into the aqueous phase, thereby obtaining the nanoemulsion consisting of a plurality of oil droplets, having a z-average droplet size of less than 100 nm.

32. The method of claim 31, wherein the pH of the nanoemulsion is in the range of 3.0 to 8.0.

33. The method of claim 31, wherein the hydrophobic flavour compound or compounds is a terpene or a mixture of terpenes, comprising pinene, myrcene and limonene.

34. The method of claim 31, wherein the weight ratio of the combined sucrose monolaurate or sucrose monopalmitate and lecithin to the hydrophobic flavour compound or compounds is between 0.3:1 and 1:1.

35. The method of claim 31, wherein the co-solvent is glycerol, added in an amount of 1-700 g/L.

36. The method of claim 31, wherein mixing is performed in a high shear mixer.

37. The method of claim 31, wherein homogenization is performed in a high pressure homogenizer up to 500 bar.

38. The method of claim 31, where the hydrophobic flavour compound or compounds is diluted down to 0.01 to 0.5 g/L.
